(19) United States
(12) Patent Application Publication
(10) Pub. No.: US 2008/0062913 A1
(43) Pub. Date: Mar. 13, 2008

(54) Method and apparatus for providing enhancement to periodical reporting criteria for user equipment (UE) positioning

(75) Inventors: Roland Zander, Lund (SE); Jesper Sandberg, Valby (DK)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/894,764

(22) Filed: Aug. 20, 2007

Related U.S. Application Data
(60) Provisional application No. 60/822,984, filed on Aug. 21, 2006.

(51) Int. Cl. H04B 7/216; G06F 3/00

(52) U.S. Cl. 370/320; 710/19

(57) ABSTRACT

The present invention provides a new and unique method and apparatus for determining the location of user equipment in a navigation system by sending one or more measurement reports from the user equipment to a network element; wherein the user equipment omits sending a measurement report if a set of conditions, where the set of conditions include the following: (1) the first positioning estimate having not been obtained; and (2) a response time having not elapsed, where the response time is configured during measurement setup.

### CROSS REFERENCE TO RELATED APPLICATIONS

This application claims benefit to provisional patent application Ser. No. 60/822,984, filed 21 Aug. 2006, which is hereby incorporated by reference in its entirety.

### BACKGROUND OF THE INVENTION

1. Field of Invention

The present invention is related to a method and apparatus for determining the location of user equipment in a navigation system, such as a Global Positioning System (GPS).

2. Description of Related Art

GPS is a satellite-based navigation system that can be used to determine the location of devices containing a GPS receiver. For example, a cellular subscriber can determine the location of his/her user equipment (UE) (if it contains a GPS receiver). It is possible to obtain both a single positioning estimate and to track movements (multiple positioning estimates are obtained). The latter feature is for instance useful for car navigation.

When GPS is used to track movements, the normal operation for GPS tracking is with an interval of 1 or 2 seconds. When using GPS, the first position calculation takes longer time than the following calculations. This is caused by the fact that the GPS receiver needs to acquire the weak signals from the satellites. When the GPS receiver has acquired enough satellites to calculate a fix, it goes from acquisition mode to tracking mode, and in this mode it can easily deliver position estimates every second or so.

In Assisted GPS (A-GPS), network elements help the GPS receiver perform the tasks required to make range measurements and position solutions. The advantages of using A-GPS include reduced latency and increased sensitivity. The specification set forth in 3GPP TS 25.331 describes the Radio Resource Control (RRC) protocol, which among other things is used for A-GPS signalling between the WCDMA base station (Node B) and the UE. According to 3GPP TS25.331, the UE shall send a periodic measurement report with the requested interval (1-2 seconds) even though the first positioning estimate has not been obtained. The measurement reports will contain an error message until the UE has obtained its first positioning estimate. As the measurement reports containing error messages are just ignored by the network, this signaling procedure is a waste of valuable bandwidth. Furthermore, this extra signaling causes increased power consumption and may depending on the applied charging scheme also cost the cellular subscriber money (unnecessary data sent to the network). Another disadvantage of sending the measurement reports containing error messages is that it reduces the likelihood of obtaining the requested amount of positioning estimates. This is due to the fact that these error messages increment the counter for the amount of reporting. The counter is used to determine if the measurement reporting is completed.

The periodic reporting criteria for UE positioning measurements follow the same procedure as for other measurement types. This causes unnecessary signalling (waste of valuable bandwidth) when running a typical GPS tracking application such as car navigation. Furthermore, the likelihood of obtaining the number of requested positioning estimates is unnecessary low.

### 8.6.7.8 Periodical Reporting Criteria

In particular, the specification 3GPP TS 25.331 describes a periodic measurement reporting procedure (section 8.6.7.8), as follows:

If the IE “Periodical Reporting Criteria” is received by the UE, the UE shall:
store the contents of the IE “Amount of Reporting” and IE “Reporting interval” in the variable MEASUREMENT_IDENTITY.

For the first MEASUREMENT REPORT message, the UE shall:
send the MEASUREMENT REPORT as soon as all requested reporting quantities are available according to the requirements and the measurement capabilities set in sections [19] and [20] for at least one measurement object stored in the variable MEASUREMENT_IDENTITY, but never later than one reporting interval after measurement initiation.

Following the first MEASUREMENT REPORT message, the UE shall:
send a MEASUREMENT REPORT message one reporting interval after the previous MEASUREMENT REPORT message;

The first and subsequent periodic MEASUREMENT REPORT messages shall only include measured results for reporting quantities that are available according to the requirements and the measurement capabilities set in sections [19] and [20] i.e. if no measured results are available and the measurement type is not UE positioning, the IE “Measured Results” shall not be included in the MEASUREMENT REPORT message. If no measured results are available and the measurement type is UE positioning, the UE shall include the IE “Measured Results” in the MEASUREMENT REPORT message in order to include the IE “UE positioning error” as specified in sections 8.6.7.19a and 8.6.7.19b of the specification 3GPP TS 25.331.

After the UE has sent a total number of MEASUREMENT REPORT messages, which equal the value indicated in the IE “Amount of reporting”, the UE shall:
terminate measurement reporting; and
delete all measurement information linked with the “Measurement identity” of the ongoing measurement from the variable MEASUREMENT_IDENTITY.

If according to subclause 8.6.7.19.1a or 8.6.7.19.1b of the specification 3GPP TS 25.331, a UE configured with a UE positioning measurement is unable to report the requested measurement results due to missing GPS assistance data and sends a MEASUREMENT REPORT containing the IE “UE positioning error” and the IE “Error reason” is set to “Assistance Data Missing”, then this is not counted in the total number of MEASUREMENT REPORT messages sent.

Overall, the UE periodical reporting criteria known in the art causes unnecessary signaling and an unnecessary low likelihood of obtaining the number of requested positioning estimates.

### SUMMARY OF THE INVENTION

In its broadest sense, the present invention provides a new and unique method and apparatus for determining the location of user equipment in a navigation system by sending one or more measurement reports from the user equipment to a network element; wherein the user equipment omits sending a measurement report if a set of conditions are fulfilled.

The set of conditions may include the following:

the first positioning estimate having not been obtained; and

a response time having not elapsed, including where the response time is configured during measurement setup or other suitable setup procedure.

The navigation system may take the form of a global positioning system (GPS), such as a satellite-based navigation system, which may include an assisted GPS, where network elements help a GPS receiver in the user equipment perform tasks required to make range measurements and position solutions.

In one embodiment, the network element may take the form of a base station, including a Node B in a Wideband Code Division Multiple Access (WCDMA) network.

The user equipment may include a receiver, such as a Global Positioning System (GPS) receiver, to determine its location in the navigation system. The receiver may be adapted to obtain both a single position estimate and to track movement, such as signals from satellites in the Global Positioning System (GPS).

The signal may take the form of a measurement report containing an error message, including a UE positioning measurement report message, until the user equipment has obtained its first positioning estimate.

The method according to the present invention may form part of a procedure where an infinite number of positioning estimates are requested, as well as a procedure where a finite number of positioning estimates are requested.

The method further includes implementing the step thereof via a computer program running in a processor, controller or other suitable module in the WLAN STA.

The apparatus may take the form of a network or system having user equipment having one or more modules configured for determining its location in such a navigation system and sending such one or more measurement reports to such a network element; wherein the user equipment omits sending a measurement report if a set of conditions are fulfilled.

The apparatus may also take the form of the user equipment having such one or more modules for performing such functionality in such a network or system.

The apparatus may take the form of a computer program product with a program code, which program code is stored on a computer readable medium, for carrying out steps of a method for performing such functionality. The apparatus may take the form of means or a module for determining the location of user equipment in a navigation system and means or a module for sending one or more measurement reports from the user equipment to a network element; wherein the user equipment omits sending a measurement report if a set of conditions are fulfilled.

In effect, the present invention would require making an exception for UE positioning measurements where no positioning estimates have been obtained.

For periodical reporting where an infinite number of positioning estimates are requested, the amount of unnecessary signaling between UE and Node B is reduced. For periodical reporting where a finite number of positioning estimates are requested, the likelihood of obtaining the requested number of positioning estimates is increased.

### BRIEF DESCRIPTION OF THE DRAWING

The drawing includes the following Figures, which are not necessarily drawn to scale:

FIGS. 1, 1a and 1b show diagrams of a Universal Mobile Telecommunications System (UMTS) packet network architecture in accordance with some embodiments of the present invention.

FIG. 2 includes FIG. 2a which shows a block diagram of a UE in accordance with some embodiments of the present invention, and FIG. 2b which shows a flowchart having basic steps of a method in accordance with some embodiments of the present invention.

FIG. 3 shows example of procedures where an infinite number of positioning estimates are requested, and includes FIG. 3a that shows a diagram of A-GPS signalling for an UE that is known in the art and FIG. 3b that shows A-GPS signalling for an UE that uses the procedure according to some embodiments of the present invention.

FIG. 4 shows procedures where two positioning estimates are requested, and includes FIG. 4a that shows A-GPS signalling for an UE that is known in the art and FIG. 4b that shows A-GPS signalling for an UE that uses the procedure according to some embodiments of the present invention.

### BEST MODE OF THE INVENTION

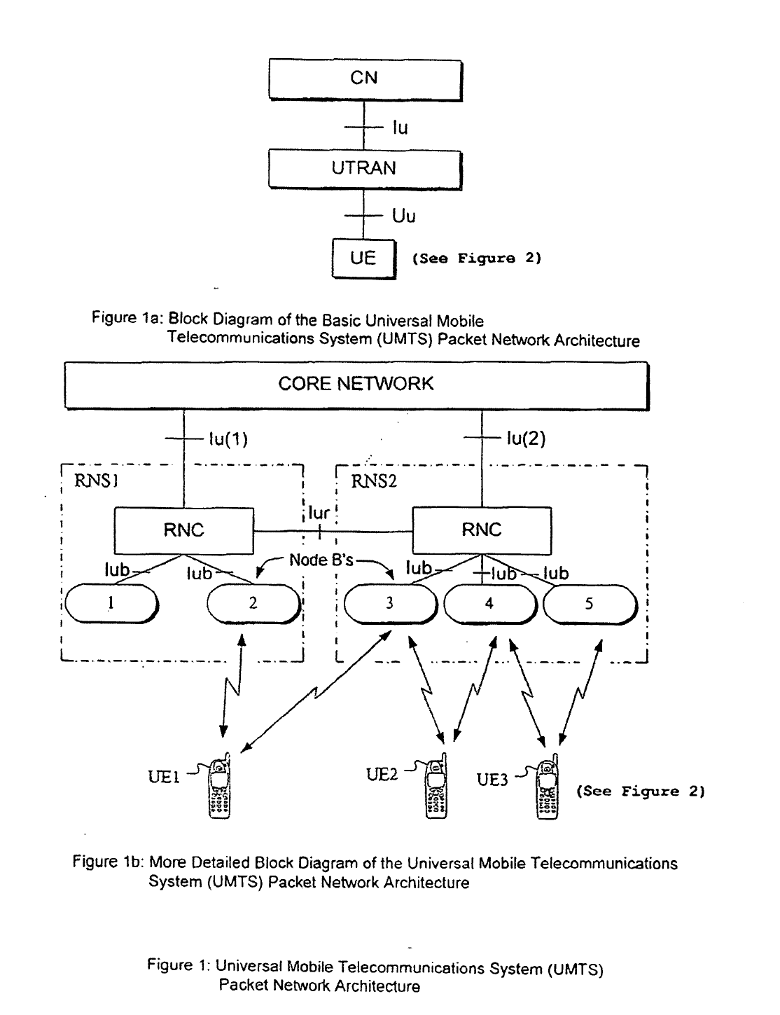

### FIG. 1

### Universal Mobile Telecommunications System (UMTS) Packet Network Architecture

By way of example, FIG. 1 shows a Universal Mobile Telecommunications System (UMTS) packet network architecture in accordance with the protocol specification of a Third Generation Partnership Project network (also known as 3GPP). Consistent with that discussed above, the 3GPP network is presently defined in a known protocol specifications, including 3GPP TS 25 331, which is hereby incorporated by reference in its entirety to the extent necessary to understand the present invention.

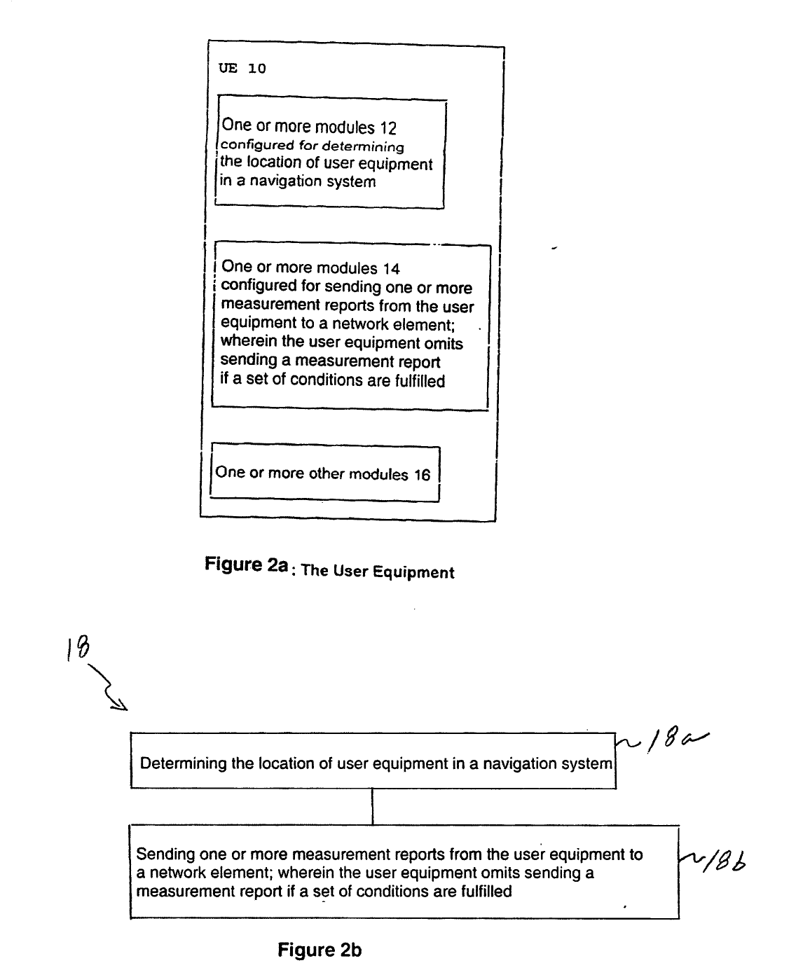

FIG. 1a shows the major elements of the UMTS packet network architecture, including user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. The present invention set forth herein is implemented in the UE consistent with that shown and described in relation to FIG. 2.

Moreover, FIG. 1b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 1a. A given UE may be in radio contact with multiple Node Bs even if one or more of the Node Bs are connected to different RNCs. For instance, a UE1 in FIG. 1b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC.

Consistent with that shown and described herein, the basic UTMS shown in FIG. 1 may include a satellite-based navigation system, such as GPS, or other suitable navigation system. For example, such a satellite-based navigation system may form part of the CN, the UTRAN, or some combination thereof. Alternatively, such a satellite-based navigation system or other suitable navigation system may form part of a separate system that works in conjunction with the basic UTMS shown in FIG. 1. In other words, the scope of the invention is not intended to be limited to where or how the navigation system is implemented in relation to the UTMS.

Further, the scope of the present invention is intended to include implementation thereof in relation to other types of networks or technologies either now known or later developed in the future, including networks or technologies such as 3GPP, 3GPP2 or 802.16.

### FIG. 2a

### UE 10

By way of example, FIG. 2a shows a block diagram of a UE 10 consistent with that shown in FIG. 1 and in accordance with the present invention. The UE 10 includes one or more modules 12 configured for determining the location of user equipment in a navigation system; one or more modules 14 for sending one or more measurement reports from the user equipment to a network element; wherein the user equipment omits sending a measurement report if a set of conditions are fulfilled, as well as one or more other modules 16 for performing other functions that do not form part of the underlying invention.

The one or more modules 12 configured for determining the location of user equipment in the navigation system are known in the art and may include a receiver, such as a Global Positioning System (GPS) receiver, to determine its location in the navigation system. The scope of the invention is not intended to be limited to any particular type or kind of module or modules 12 for performing the basic functionality for determining the location of user equipment in the navigation system, and may include functionality and techniques for the performing the same either now known or later developed in the future.

In operation, the one or more modules 14 may send the one or more measurement reports from the user equipment (UE) in FIG. 1 to a network element, such as a Node B, only after the first positioning estimate has been received based on a non-mandatory set of conditions. According to the present invention, the UE does not have to send a UE positioning measurement report message if the conditions below are fulfilled:

1. The first positioning estimate has not been obtained; and

2. The response time has not elapsed, the response time being configured during measurement setup or other suitable setup procedure.

The scope of the invention is intended to include the UEs both now known and later developed in the future, including a mobile phone, a lap top or personal computer, a personal digital assistant (PDA)

FIG. 2b shows a flowchart 18 having basic steps 18a, 18b in accordance with some embodiments of the present invention.

### Implementation of the Functionality of the Module(s) 14

By way of example, and consistent with that described herein, the functionality of the module(s) 14 may be implemented using hardware, software, firmware, or a combination thereof, although the scope of the invention is not intended to be limited to any particular embodiment thereof. In a typical software implementation, the module(s) 14 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module(s) 14 being a stand alone modules, multiple modules, or even in the combination with other circuitry for implementing another module, such as module (s) 12.

The other module 16 and the functionality thereof are known in the art, do not form part of the underlying invention per se, and are not described in detail herein. For example, the other modules 14 may include other modules that formal part of a typical UE, mobile telephone or terminal, such as a UMTS subscriber identity module (USIM) and mobile equipment (ME) module, which are known in the art and not described herein.

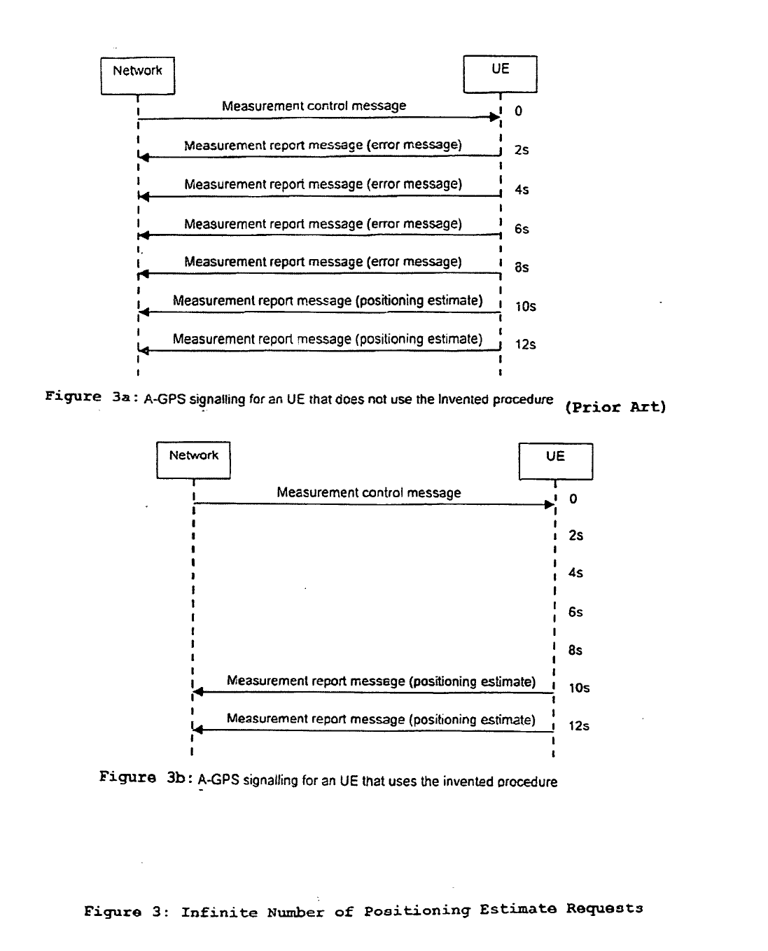

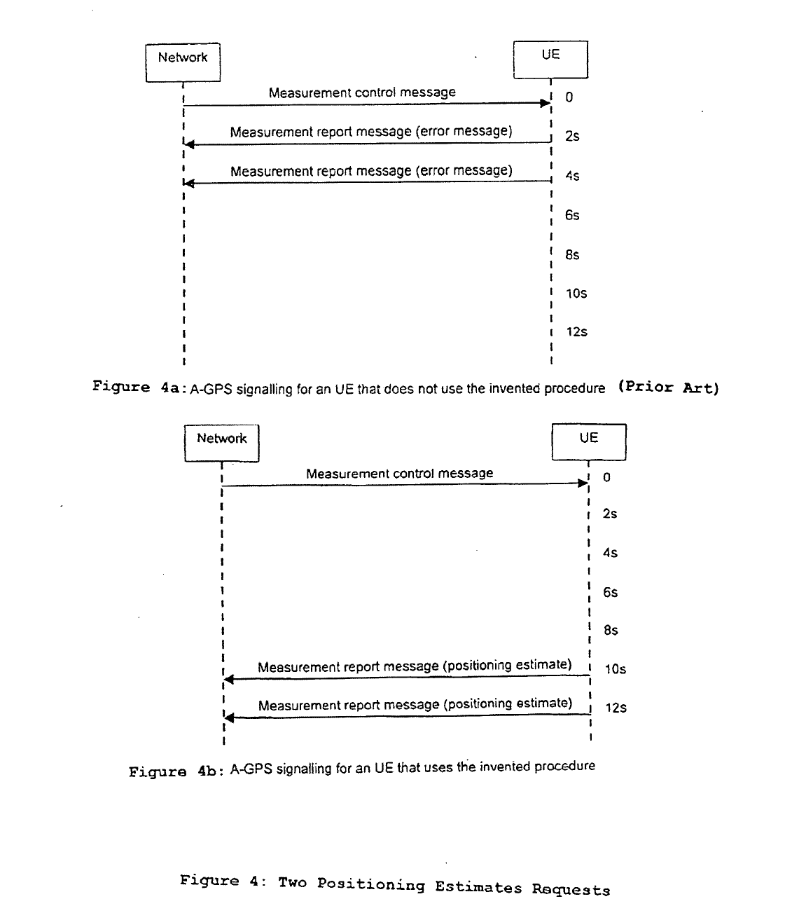

### FIGS. 3 and 4

### Typical Examples

By way of example, FIGS. 3 and 4 show typical example where the present invention may be implemented. A typical case may occurs when starting a car navigation application (request for an infinite number of positioning estimates). In poor GPS signal conditions, it may take 20 seconds for the UE to obtain the first positioning estimate. If the application has a periodic interval of 1 second, this means that the UE may send 20 measurement reports containing an error message before the first positioning estimate is obtained. These messages are just discarded by the network. If the UE uses the procedure according to the present invention, these 20 measurement reports do not have to be sent. This reduces UE power consumption and decreases the amount of signaling in the network. Another typical case occurs when the network requests a finite number of positioning estimates with a short periodic interval. If measurement reports containing error messages are sent until the first positioning estimate is obtained, there is a risk that the measurement reporting will be completed without having obtained a single positioning estimate. If the UE uses the procedure according to the present invention, the number of requested positioning estimates will be obtained (if 2 is fulfilled as well).

FIGS. 3a and 3b show the A-GPS signaling between the network (e.g. Node B (see FIG. 1b)) and an UE during the first 12 seconds of an A-GPS session. FIG. 3a shows the signalling for an UE that does not use the procedure according to the present invention, while FIG. 3b shows the signalling for an UE that uses the procedure according to the present invention. First, a measurement control message specifying the A-G PS session parameters is sent from the network (e.g. Node B (see FIG. 1b)) to the UE. An infinite number of positioning estimates, a periodical interval of 2 seconds and a response time of 32 seconds are requested by the network. The UE obtains the first positioning estimate in 9 seconds. In FIG. 3a, it can be seen that measurement reports containing error messages are sent with an interval of 2 seconds until the first position estimate is obtained. As can be seen in FIG. 3b, the present invention can omit sending measurement reports until the first positioning estimate has been obtained (response time has not elapsed). This saves valuable bandwidth and reduces power consumption.

In FIGS. 4a and 4b, two positioning estimates are requested by the network (e.g. Node B (see FIG. 1b)). All other parameters are identical to the previous scenario. The UE obtains the first positioning estimate in 9 seconds. In FIG. 4a, it can be seen that two measurement reports containing error messages are sent to the network. Hence, no positioning estimates have been obtained before the measurement reporting is completed. As can be seen in FIG. 4b, the present invention can omit sending measurement reports until the first positioning estimate has been obtained (response time has not elapsed). In this case, the UE obtains the two requested positioning estimates and sends them to the network. Hence, the present invention increases the likelihood of obtaining the number of requested positioning estimates.

### Observations

For periodical reporting where an infinite number of positioning estimates are requested, the main advantage of the invented procedure is that it reduces the power consumption when using A-GPS. This is obtained by reducing the amount of unnecessary signalling between UE and Node B (WCDMA base station). This saves valuable bandwidth as well as reduces the power consumption. Furthermore, the UE user does not want to pay for data that is sent unnecessarily. For periodical reporting where a finite number of positioning estimates are requested, the main advantage of the invented procedure is that the likelihood of obtaining the requested number of positioning estimates is increased. Another advantage (valid for both infinite and finite positioning estimate requests) is that the change in 3GPP TS25.331 is forward compatible, i.e. existing terminals will still be compliant with the modified specification.

The disadvantage of using the invented procedure is that it may increase the complexity of UE periodical reporting.

### Abbreviations

A-GPS—Assisted Global Positioning System

Node B—Base station in a WCDMA network

UE—User Equipment

UMTS—Universal Mobile Telecommunication System

WCDMA—Wideband Code Division Multiple Access

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What we claim is:

1. A method comprising:
determining the location of user equipment in a navigation system; and
sending one or more measurement reports from the user equipment to a network element; wherein the user equipment omits sending a measurement report if a set of conditions are fulfilled.

2. A method according to claim 1, wherein the set of conditions includes:
the first positioning estimate having not been obtained; and
a response time having not elapsed, including where the response time is configured during measurement setup.

3. A method according to claim 1, wherein the navigation system is a global positioning system (GPS), such as a satellite-based navigation system.

4. A method according to claim 3, wherein the navigation system includes an assisted GPS, where network elements help a GPS receiver in the user equipment perform tasks required to make range measurements and position solutions.

5. A method according to claim 1, wherein the network element is a base station, including a Node B in a Wideband Code Division Multiple Access (WCDMA) network.

6. A method according to claim 1, wherein the user equipment includes a receiver, such as a Global Positioning System (GPS) receiver, to determine its location in the navigation system.

7. A method according to claim 6, wherein the receiver is adapted to obtain both a single position estimate and to track movement.

8. A method according to claim 6, wherein the receiver is adapted to receive weak signals, such as signals from satellites in the Global Positioning System (GPS).

9. A method according to claim 1, wherein the method further comprises implementing the step of the method via a computer program running in a processor, controller or other suitable module in the user equipment.

10. A method according to claim 1, wherein the method forms part of a procedure where an infinite number of positioning estimates are requested.

11. A method according to claim 1, wherein the method forms part of a procedure where a finite number of positioning estimates are requested.

12. A network comprising:
user equipment having one or more modules configured for determining its location in a navigation system; and
the one or more modules also being configured for sending one or more measurement reports to a network element; wherein the user equipment omits sending a measurement report if a set of conditions are fulfilled.

13. A network according to claim 12, wherein the set of conditions includes:
the first positioning estimate having not been obtained; and
a response time having not elapsed, including where the response time is configured during measurement setup.

14. A network according to claim 12, wherein the navigation system is a global positioning system (GPS), such as a satellite-based navigation system.

15. A network according to claim 14, wherein the navigation system includes an assisted GPS, where network elements help a GPS receiver in the user equipment perform tasks required to make range measurements and position solutions.

16. A network according to claim 12, wherein the network element is a base station, including a Node B in a Wideband Code Division Multiple Access (WCDMA) network.

17. A network according to claim 12, wherein the user equipment includes a receiver, such as a Global Positioning System (GPS) receiver, to determine its location in the navigation system.

18. A network according to claim 17, wherein the receiver is adapted to obtain both a single position estimate and to track movement.

19. A network according to claim 17, wherein the receiver is adapted to receive weak signals, such as signals from satellites in the Global Positioning System (GPS).

20. A network according to claim 12, wherein an infinite number of positioning estimates are requested.

21. A network according to claim 12, wherein a finite number of positioning estimates are requested.

22. User equipment comprising:
one or more modules configured for determining its location in a navigation system, the one or more modules also being configured for sending one or more measurement reports to a network element; wherein the user equipment omits sending a measurement report if a set of conditions are fulfilled.

23. User equipment according to claim 22, wherein the set of conditions includes:
the first positioning estimate having not been obtained; and
a response time having not elapsed, including where the response time is configured during measurement setup.

24. User equipment according to claim 22, wherein the navigation system is a global positioning system (GPS), such as a satellite-based navigation system.

25. User equipment according to claim 24, wherein the navigation system includes an assisted GPS, where network elements help a GPS receiver in the user equipment perform tasks required to make range measurements and position solutions.

26. User equipment according to claim 22, wherein the network element is a base station, including a Node B in a Wideband Code Division Multiple Access (WCDMA) network.

27. User equipment according to claim 22, wherein the user equipment includes a receiver, such as a Global Positioning System (GPS) receiver, to determine its location in the navigation system.

28. User equipment according to claim 27, wherein the receiver is adapted to obtain both a single position estimate and to track movement.

29. User equipment according to claim 27, wherein the receiver is adapted to receive weak signals, such as signals from satellites in the Global Positioning System (GPS).

30. User equipment according to claim 22, wherein an infinite number of positioning estimates are requested.

31. User equipment according to claim 22, wherein a finite number of positioning estimates are requested.

32. A computer program product with a program code, which program code is stored on a computer readable medium, for carrying out steps of a method comprising determining the location of user equipment in a navigation system and sending one or more measurement reports from the user equipment to a network element; wherein the user equipment omits sending a measurement report if a set of conditions are fulfilled, when the computer program is run in a module of user equipment.

33. Apparatus comprising:
means for determining the location of user equipment in a navigation system; and
means for sending one or more measurement reports from the user equipment to a network element; wherein the user equipment omits sending a measurement report if a set of conditions.

34. Apparatus according to claim 33, wherein the non-mandatory set of conditions includes:
the first positioning estimate having not been obtained; and
a response time having not elapsed, including where the response time is configured during measurement setup.

35. Apparatus according to claim 34, wherein the navigation system is a global positioning system (GPS), such as a satellite-based navigation system.
